(19) United States
(12) Patent Application Publication
(10) Pub. No.: US 2026/0336026 A1
(43) Pub. Date: Oct. 29, 2026

(54) METHOD FOR CUTTING CLOSED CONTOURS INTO A PLATELIKE WORKPIECE

(71) Applicant: TRUMPF Werkzeugmaschinen SE + Co. KG, Ditzingen (DE)

(72) Inventors: Patrick MACH, Korb (DE); Michael KRUTZKE, Sindelfingen (DE); Markus BLASCHKA, Schönaich (DE)

(21) Appl. No.: 19/704,418

(22) Filed: Jun. 11, 2026

Related U.S. Application Data
(63) Continuation of application No. PCT/EP2024/083824, filed on Nov. 27, 2024.

(30) Foreign Application Priority Data
Dec. 12, 2023 (DE) 10 2023 134 811.6

(51) Int. Cl. B23K 26/08; B23K 26/03; B23K 26/38; B23K 103/04

(52) U.S. Cl. CPC B23K 26/0892; B23K 26/032; B23K 26/38; B23K 2103/04

(57) ABSTRACT

A method for cutting a closed contour into a platelike workpiece using a laser beam, the method including moving the laser beam over the workpiece using a machining head. The method further includes reducing an advancement speed of the machining head at a definable distance before cutting of the contour is completed.

### CROSS REFERENCE TO RELATED APPLICATIONS

This application is a continuation of International Application No. PCT/EP 2024/083824 (WO 2025/124906A1 ), filed on Nov. 27, 2024, and claims benefit to German Patent Application No. DE 10 2023 134 811.6, filed on Dec. 12, 2023. The aforementioned applications are hereby incorporated by reference herein.

### FIELD

The invention relates to a method for cutting closed contours into a platelike workpiece by means of a laser beam and to a laser cutting machine.

### BACKGROUND

Closed contours can, for example, be incorporated into the workpiece as recesses for internal drilling or the like. In this case, the finished part is the remaining workpiece, while the cut-out contours are scrap pieces. In the reverse case, the cut-out parts are the finished parts and the remaining residual grid forms the scrap piece.

The path of the machining head is usually programmed in such a way that the starting point and the end point of the contour cut are identical. The laser is switched off once the end point has been reached. However, the contour is already cut free before the starting point of the laser path is reached. Due to the weight of the cut-out parts, these may tilt downwards while the laser is still active. This results in irregularities in the contour in the region of the starting point and end point of the contour cut. These irregularities can include discoloration of the material due to excessive heat input or splashes of molten material, or distortions in the contour. These irregularities are undesirable and may necessitate reworking of the finished part.

To reduce these problems, DE 10 2015 221 243 A1 has proposed switching off the laser beam as soon as the cut-out part tilts after being cut free, i.e., before the laser beam returns to the starting point of the cutting path. Due to the circular diameter of the laser beam, however, switching off the laser beam immediately after the contour has been cut free may result in the formation of a lead-in nib, i.e., a small piece of material protruding beyond the cut edge of the contour that is not captured by the laser beam if the laser beam is switched off before the starting point of the cut is reached again.

### SUMMARY

In an embodiment, the present disclosure provides a method for cutting a closed contour into a platelike workpiece using a laser beam, the method comprising moving the laser beam over the workpiece using a machining head, and reducing an advancement speed of the machining head at a definable distance before cutting of the contour is completed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a platelike workpiece with bore cutouts produced by a laser beam;

FIG. 2 shows a schematic representation of the laser beam at the beginning and end of cutting a bore cutout from the workpiece from FIG. 1;

FIG. 3 shows a diagram of measuring the distance of the machining head of a laser cutting machine for detecting a bore cutout being cut free;

FIG. 4 shows a schematic representation of the laser beam at the beginning and end of cutting a bore cutout, with a measure for avoiding/reducing a lead-in nib in the bore cutout; and

FIG. 5 shows the entire path of the laser beam for cutting a bore cutout using the measure from FIG. 4.

### DETAILED DESCRIPTION

In an embodiment, the present disclosure provides a method for further reducing the irregularities that occur in the region of the end of the cut when cutting closed contours.

is the foregoing advantages are achieved according to the present disclosure by a method for cutting closed contours into a platelike workpiece by means of a laser beam, which is moved over the workpiece by means of a machining head, characterized in that the advancement speed of the machining head is reduced at a definable distance before the cutting of the contour is completed.

By reducing the advancement speed of the machining head at a definable distance to the programmed end of the cut, as described in the present disclosure, the cutting front edge of the laser cut is reduced, so that the cutting front forms an angle of approximately 90° with the workpiece surface. This can reduce material discoloration in the region of the cut end. The programmed cut end can preferably coincide with the starting point of the contour cut.

The advancement speed can be reduced, for example, at a distance of 2 mm to 8 mm before reaching the end of the cut. The advancement speed of the machining head can preferably be reduced to 0.5 m/min, in particular to 0.1 m/min.

Preferably, the laser beam can also be pulsed and/or operated at reduced power at a definable distance before the cutting of the contour is completed. This measure will also help to further reduce discoloration of the material. It has proven advantageous if the laser beam is operated at a definable distance before the cutting of the contour is completed with a pulse frequency of 100 Hz and a power between 400 W and 1500 W.

If the advancement speed of the machining head and the pulse frequency and power of the laser beam are reduced simultaneously and linearly, material discoloration can be almost completely avoided by the significant reduction in the linear energy of the laser cut.

The complete cutting free of the contour can be detected by measuring the distance between the machining head and the workpiece and/or by an optical sensor device. If the distance measurement and/or optical sensor device indicates that the area has been completely cut free, the laser beam can be switched off. This prevents the laser beam from hitting a workpiece part that has already been cut free and tilted, which could lead to molten splashes or distortions in the contour. The distance between the machining head and the workpiece can be measured capacitively, for example.

Process reliability can be improved if the cutting free of the contour is monitored both by measuring the distance and by optical inspection, triggering the laser beam switch-off accordingly. Upon an abrupt change in the distance between the machining head and the workpiece, and a simultaneous change in the intensity of the scattered light detected by the optical sensor device, the cutting free of the contour can be reliably detected and the laser beam switched off. When using only a distance measurement signal, for example, vibrations of the platelike workpiece can cause the laser beam to shut off prematurely. To avoid these premature shutdowns, the scattered light in the region of the cut end can be detected. Due to the reduced advancement speed of the machining head in this region, the intensity of the scattered light increases there. An increase in the intensity of the scattered light can therefore be used to substantiate the detection of the cutting free of the contour by an increase in the distance measurement signal.

To avoid a lead-in nib at the cut edge, at the beginning of the contour cut, the laser beam can be moved a fraction of its diameter wide and perpendicular to the programmed cutting path from the machining head into the contour if this is the finished part to be produced, or into the remaining workpiece if this is the finished part, and the machining head is moved back to the starting point of the programmed cutting path, and the contour is cut. While the machining head is returning to the starting point of the programmed cutting path, the laser beam can be switched off, and then switched on again before the subsequent cutting of the contour. Instead of a material protrusion, this creates a small depression in the cut edge, which is generally more visually acceptable than a material protrusion.

Additionally or alternatively, prior to the complete cutting free of the contour, the laser beam can be moved a fraction of its diameter away from the machining head into the contour if this is the finished part to be produced, or into the remaining workpiece if this is the finished part, and the cutting free of the contour is completed in this position. This measure also creates a small indentation in the cut edge. Preferably, the laser beam can be moved 5 mm into the finished part at an angle of 45° before reaching the end point of the cutting-free process. The movement of the laser beam into the finished part can be, for example, 0.1 to 0.2 mm, so that the resulting indentation in the cut edge is hardly noticeable.

The present disclosure also relates to a laser cutting machine for processing platelike workpieces with a machining head for guiding a laser beam and a control device for regulating the advancement of the machining head and the laser beam, wherein the laser cutting machine is set up to carry out a method according to embodiments of the present disclosure.

In particular, the laser cutting machine can be equipped with a device for measuring the distance between the machining head and a workpiece and with an optical sensor device for detecting scattered light.

Further features and advantages of the present disclosure can be found in the description and the drawings. According to the present disclosure, the features mentioned above and those yet to be explained further can be used in each case individually or together in any desired expedient combinations. The embodiments shown and described should not be understood as an exhaustive list, but rather are of an exemplary character.

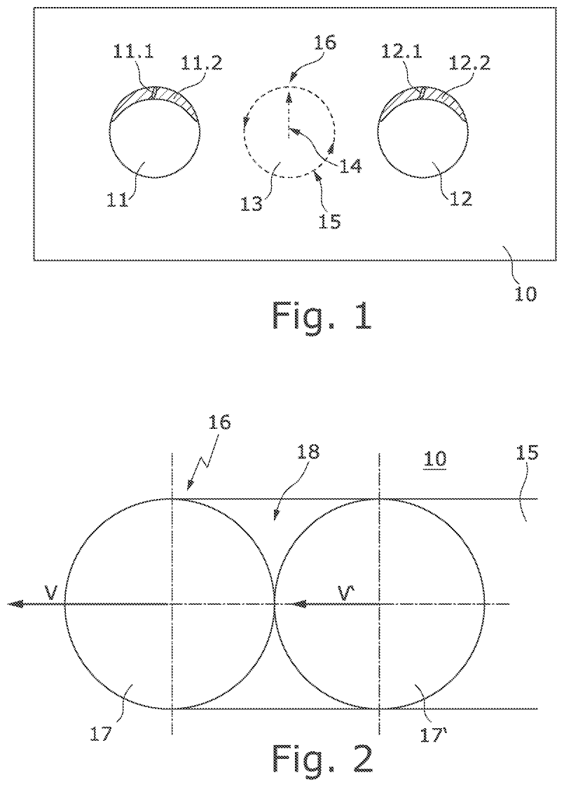

FIG. 1 shows a platelike workpiece 10, for example a sheet of steel, from which two circular bore cutouts 11, 12 have been cut. Furthermore, the path 14, 15 of a laser beam 17 (FIG. 2) for cutting a third bore cutout 13 into the workpiece 10 is shown. For this purpose, the laser beam 17 is first inserted into the center of the bore cutout 13 and then the laser beam 17 is moved outwards on a radial path 14 until the desired outer diameter of the bore cutout 13 is reached at the point 16. From the point 16 onwards, the laser beam 17 is guided on a circular path 15 until the material of the bore cutout 13 is completely cut free shortly before reaching the point 16 and falls out of the workpiece 10.

At the point 16, the workpiece 10 experiences a relatively high heat input from the laser beam 17, since it first strikes the point 16 from the radial path 14 and is then deflected onto the circular path 15. At the end of the circular path 15, heat is again introduced by the laser beam 17 in the region of the point 16. Furthermore, the bore cutout 13 can tilt downwards after being cut free. This leads to irregularities 11.1, 12.1 in the cut edges 11.2, 12.2 of the bore cutouts 11 to 13 as shown by the example of bore cutouts 11 and 12. These irregularities can be material discolorations, molten material splashes or lead-in nibs 18 (FIG. 2).

To minimize these irregularities 11.1, 12.1, the advancement of the laser beam 17 is reduced in speed from V to V′ before the completion of the circular path 15, i.e., before the bore cutout 13 has been cut free completely, as shown in FIG. 2. Preferably, the speed V′ is only 0.5 m/min. In the greatly enlarged and schematic representation of FIG. 2, the circular cross-section of the laser beam 17 can be seen at the beginning of the circular path 15 and 17′ at the end of the circular path 15. When position 17′ is reached, the bore cutout 13 is completely cut free, and the laser beam 17′ can be switched off at this position. However, a lead-in nib 18 of the workpiece 10 remains and protrudes into the bore cutout 13. This nib 18 is caused by the circular cross-section of the laser beam 17, 17′ and the switching off of the laser beam 17′ before reaching the starting position 17 again.

In addition to reducing the advancement speed V, the power of the laser beam 17′ can also be reduced, for example from 1500 W to 400 W. Furthermore, the pulse frequency of the laser beam 17′ can also be reduced from, for example, 20,000 Hz to 100 Hz. These measures lead to a reduction in the linear energy and thus to a further reduction of the irregularities 11.1, 12.1 at the cut edges 11.2, 12.2.

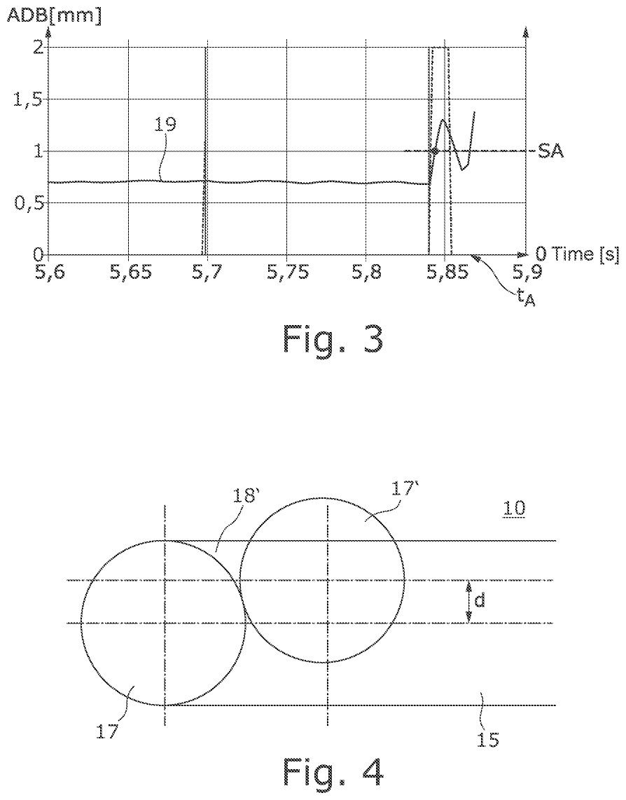

To reliably detect when the bore cutout 13 has been cut free and thus enable the laser beam 17′ to be shut off in time to prevent unnecessary heat input into the workpiece 10, the distance 19 between the machining head for guiding the laser beam 17 and the workpiece 10 can be monitored in an end section of the path 15 of the laser beam 17, as shown in FIG. 3. When the bore cutout 13 is completely cut free, it falls out of the workpiece 10. This increases the distance between workpiece 10 and the laser processing head. If a threshold value SA is exceeded by the distance 19, the laser beam 17′ is switched off. The distance measurement can also be validated using an optical measurement signal. By reducing the advancement speed from V to V′, the intensity of the scattered light on the laser path 15 increases, which can be detected, for example, by a photodiode. If an increase in the distance 19 above the threshold value SA coincides with an increase in the intensity of the scattered light, it can be safely assumed that the bore cutout 13 has been cut free and that the laser beam 17′ can therefore be switched off. The programmed path end of the machining head is reached at the time t_{A}, i.e., after the laser beam is switched off.

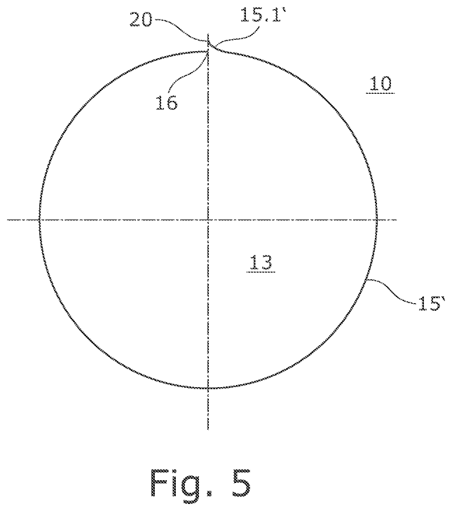

FIG. 4 and FIG. 5 illustrate a measure by which the lead-in nib 18 from FIG. 2 can be reduced to a smaller nib 18′. For this purpose, the laser beam 17′ is moved into the workpiece 10 by a distance d of, for example, 0.1 to 0.2 mm in an end section 15.1 of the laser path 15. FIG. 4 shows the end position 17′ of the laser beam when switched off and the reduced lead-in nib 18′. FIG. 5 shows the entire programmed laser path 15′ with the end section 15.1′ running obliquely into the workpiece 10. The end point 20 of the laser beam 17′ reached is located radially outside the starting point 16 of the laser path 15′. This creates a small indentation in the workpiece 10. The lead-in nib 18, 18′ can even be completely avoided if, in addition, the radial laser path 14 shown in FIG. 1 is extended to the radial distance of the point 20 before cutting the circular path 15 begins.

In the exemplary embodiment shown in the figures, the workpiece 10 is the finished part, while the bore cutouts 11, 12 and 13 are scrap pieces. The method according to the present disclosure with the various measures for reducing the irregularities 11.1 and 12.1 can be carried out similarly if the cutouts 11, 12 and 13 are the finished parts and the remaining workpiece 10 is the scrap piece. In this case, as shown in FIG. 1, the laser beam 17 is directed radially from the outside onto the circular path 15. To reduce lead-in nibs 18, the laser beam 17 is moved into these finished parts 12 to 13 and not into the workpiece 10 before cutting free the cutouts 11, 12 and 13. The changes in laser beam parameters such as advancement speed, power and pulse frequency are independent of which parts are the finished parts. Likewise, the detection of the cutting-free of the cutouts 11 to 13 via a distance measurement with optional optical validation check and thus the automatic switching off of the laser beam remains unchanged if the cutouts 11 to 13 are the finished parts.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for cutting a closed contour into a platelike workpiece using a laser beam, the method comprising:
moving the laser beam over the workpiece using a machining head, and reducing an advancement speed of the machining head at a definable distance before cutting of the contour is completed.

2. The method according to claim 1, wherein the advancement speed of the machining head is reduced to 0.5 m/min.

3. The method according to claim 1, comprising pulsing the laser beam and/or operating the laser beam with reduced power at the definable distance before the cutting of the contour is completed.

4. The method according to claim 3, wherein the laser beam is operated at a pulse frequency of 100 Hz and a power between 400 W and 1500 W at the definable distance before the cutting of the contour is completed.

5. The method according to claim 4, wherein the advancement speed of the machining head and the pulse frequency and power of the laser beam are reduced simultaneously and linearly.

6. The method according to claim 1, comprising detecting a complete cutting free of the contour by measuring a distance between the machining head and the workpiece and/or by an optical sensor.

7. The method according to claim 6, wherein the distance between the machining head and the workpiece is measured capacitively.

8. The method according to claim 6, wherein, upon an abrupt change in the distance between the machining head and the workpiece and a simultaneous change in an intensity of scattered light detected by the optical sensor, the complete cutting free of the contour is detected and the laser beam is switched off.

9. The method according to claim 1, comprising, at a beginning of a contour cut, moving the laser beam a fraction of its diameter wide and perpendicular to a programmed cutting path from the machining head into the contour if the contour forms part of an unfinished part, or into a remaining portion of the workpiece if the contour forms a finished part, and wherein the machining head is moved back to a starting point of the programmed cutting path, and the contour is cut.

10. The method according to claim 1, wherein, prior to the contour being completely cut free, the laser beam is moved to a first position a fraction of its diameter away from the machining head into the contour if the contour forms part of an unfinished part, or moved to a second position a fraction of its diameter away from the machining head into a remaining portion of the workpiece if the contour forms a finished part, and the cutting free of the contour is completed in the first or second position.

11. The method according to claim 10, wherein the laser beam is moved 5 mm into a finished part at an angle of 45° before reaching an end point of a cutting-free process.

12. The method according to claim 9, wherein the laser beam is moved 0.1 to 0.2 mm into a finished part.

13. A laser cutting machine for processing platelike workpieces with a machining head for guiding a laser beam and a controller for regulating advancement speed of the machining head and the laser beam, wherein the laser cutting machine is configured to carry out the method according to claim 1.

14. The laser cutting machine according to claim 13, comprising a device configured to measure a distance between the machining head and the workpiece and an optical sensor configured to detect scattered light.

15. The method according to claim 2, wherein the advancement speed of the machining head is reduced to 0.1 m/min.
